(19) United States
(12) Patent Application Publication
(10) Pub. No.: US 2011/0142031 A1
(43) Pub. Date: Jun. 16, 2011

(54) METHOD AND APPARATUS FOR DYNAMICALLY ASSIGNING BORDER ELEMENTS IN A VOICE OVER INTERNET PROTOCOL NETWORK

(76) Inventors: JAMES JACKSON, Austin, TX (US); Chaoxin Qiu, Austin, TX (US); Mehrad Yasrebi, Austin, TX (US)

(21) Appl. No.: 12/634,762

(22) Filed: Dec. 10, 2009

(51) Int. Cl. H04L 12/66

(52) U.S. Cl. 370/352

(57) ABSTRACT

In one embodiment, the present disclosure is a method and apparatus for dynamically assigning border elements in a Voice over Internet Protocol network. In one embodiment, a method for registering an endpoint device to a core Internet Protocol network includes selecting a border element in the network, where the border element is selected based on monitored data relating to at least one of: a condition of the network and a condition of at least one component of the network and sending a message to the endpoint device instructing the endpoint device to register with the network via the border element.

### FIELD OF THE DISCLOSURE

The present disclosure relates generally to Voice over Internet Protocol (VoIP) technology and relates more particularly to methods for assigning border elements to VoIP endpoints.

### BACKGROUND

After recovery from a catastrophic failure (e.g., a wide-scale power outage), a VoIP network can easily become overloaded when all of its endpoints attempt to re-register with the network at once. For example, in a session initiation protocol (SIP)-based environment, many, most, or all of the endpoints may issue SIP REGISTER messages within the same small window of time. The overload on the network can cause a large percentage of these SIP REGISTER messages to fail with a SIP error or a timeout.

An endpoint that receives a SIP error or a timeout may attempt to re-transmit the SIP REGISTER message. This re-transmission process is controlled by a timer in the endpoint. However, the timers in all of the endpoints are typically set to the same value, such that the endpoints are likely to attempt re-transmission within the same small window of time. As such, the pattern of globally synchronized registration attempts and failures will continue.

To further complicate matters, the VoIP infrastructure may become so overwhelmed that even calls from registered endpoints may fail. These failed calls may in turn cause more endpoints to attempt re-registration, thereby exacerbating the ongoing registration flood. This snowballing effect can ultimately lead to major or total failure of the VoIP network.

### SUMMARY

In one embodiment, the present disclosure is a method and apparatus for dynamically assigning border elements in a Voice over Internet Protocol network. In one embodiment, a method for registering an endpoint device to a core Internet Protocol network includes selecting a border element in the network, where the border element is selected based on monitored data relating to at least one of: a condition of the network and a condition of at least one component of the network and sending a message to the endpoint device instructing the endpoint device to register with the network via the border element.

### BRIEF DESCRIPTION OF THE DRAWINGS

The teaching of the present disclosure can be readily understood by considering the following detailed description in conjunction with the accompanying drawings, in which:

FIG. 1 is a schematic diagram illustrating an exemplary network within which an embodiment of the present disclosure is deployed;

FIG. 2 is a flow diagram illustrating one embodiment of a method for registering an endpoint device to a core network, according to the present disclosure;

FIG. 3 is a flow diagram illustrating a second embodiment of a method for registering an endpoint device to a core network, according to the present disclosure;

FIG. 4 is a flow diagram illustrating a third embodiment of a method for registering an endpoint device to a core network, according to the present disclosure; and

FIG. 5 is a high level block diagram of the border element assignment method that is implemented using a general purpose computing device.

To facilitate understanding, identical reference numerals have been used, where possible, to designate identical elements that are common to the figures.

### DETAILED DESCRIPTION

In one embodiment, the present disclosure is a method and apparatus for dynamically assigning border elements in a VoIP network. By dynamically assigning border elements to VoIP endpoints and prioritizing endpoint registration, registration floods that tend to occur during catastrophic VoIP network failures can be controlled and mitigated. Dynamic assignment of border elements also improves load distribution and fault isolation applications.

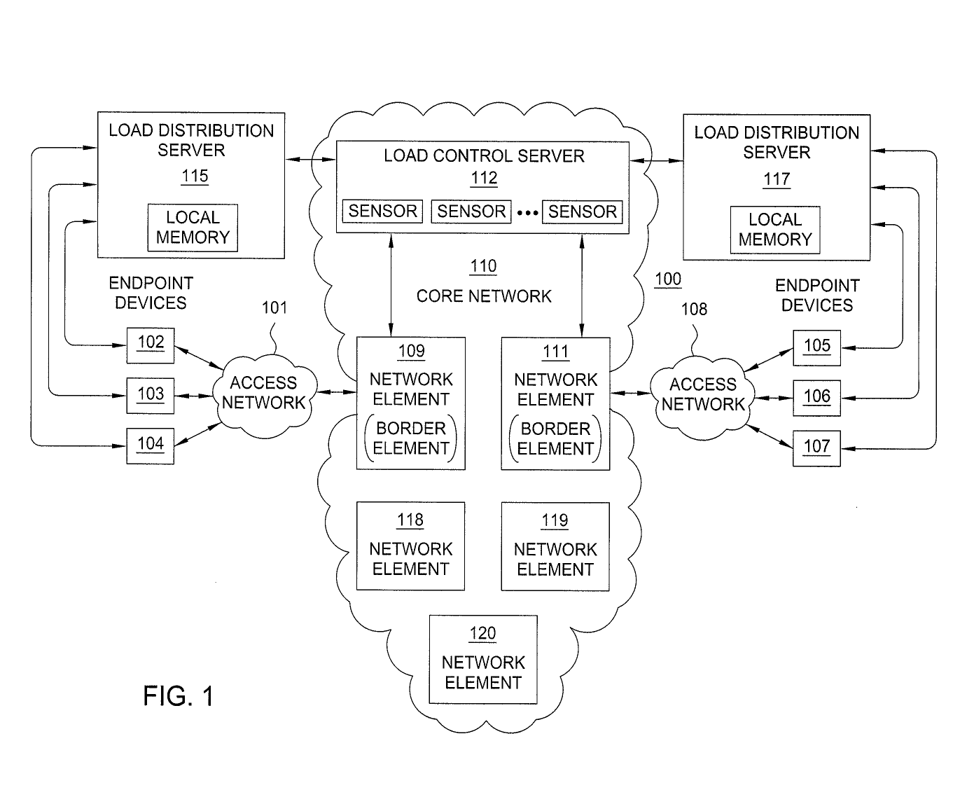

FIG. 1 is a schematic diagram illustrating an exemplary network 100 (e.g., an Internet Protocol (IP) Multimedia Subsystem network) within which an embodiment of the present disclosure is deployed. Components of the network 100 may be combined and/or rearranged without loss of scope or intent. An IP network is broadly defined as a network that uses Internet Protocol to exchange data packets. Exemplary IP Multimedia Subsystem (IMS) networks include Internet protocol (IP) networks such as Voice over Internet Protocol (VoIP) networks, Service over Internet Protocol (SoIP) networks, and the like.

In one embodiment, the network 100 comprises a plurality of endpoint devices 102-104 configured for communication with the core network 110 (e.g., an IP-based core backbone network supported by a service provider) via an access network 101. Similarly, another plurality of endpoint devices 105-107 are configured for communication with the core network 110 via another access network 108. The network elements 109 and 111 may serve as gateway servers or edge routers for the core network 110.

The endpoint devices 102-107 may comprise customer endpoint devices such as personal computers, laptop computers, personal digital assistants (PDAs), mobile phones, smart phones, gaming consoles, or the like. The access networks 101 and 108 serve as conduits to establish connections between the endpoint devices 102-107 and the network elements (NEs) 109 and 111 of the core network 110. The access networks 101 and 108 may each comprise a Digital Subscriber Line (DSL) network, a broadband cable access network, a Local Area Network (LAN), a Wireless Access Network (WAN), a third-party network, or the like. The access networks 101 and 108 may be directly connected to the NEs 109 and 111 of the core network 110, or may be indirectly connected to the NEs 109 and 11 through another network.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a proxy server, a border element, a firewall, a switch, and the like. In one embodiment, the NEs 109 and 111 are implemented as border elements that are the first application level contact point of at least some of the endpoint devices 102-107 with the core network 110. An NE may also reside within the core network 110 (e.g., NEs 118-120) and may be used as a SIP server, a device registrar, a core router, or like device.

The network 100 also comprises a plurality of load distribution servers 115-117 and at least one load control server 112. As discussed in further detail below, the load distribution servers 115-117 and the load control server 112 cooperate to direct the endpoint devices 102-107 to register with appropriate border elements 109 and 111 of the core network 110. The load distribution servers reside outside of the core network 110 and communicate with the endpoint devices 102-107 and with the load control server 112, and may include local memory. The load control server 112 resides inside the core network 110 and communicates with the core network 110 and the components thereof (e.g., NEs 109 and 111) in order to directly monitor and record the conditions (health, load, etc.) of the core network 110 and its components. To this end, the load control server 112 may include monitoring applications that monitor the workload and health of the core network 110. In one embodiment, the load control server 112 is further configured to track the number of endpoint devices whose registrations have expired from the core network 110 over a window of time. This helps the load control server 112 to detect catastrophic failures.

The network 100 is described only to provide an illustrative environment in which packets for voice, data, and multimedia services are transmitted on IP Multimedia Subsystem (IMS) networks. The present disclosure is not limited for use with the illustrated configuration. For example, for ease of illustration, only a limited number of endpoint devices, network elements, access networks, load distribution servers, and the like have been depicted in FIG. 1. However, those skilled in the art will appreciate that embodiments of the present disclosure are highly scalable and may be implemented within networks including any number of these components.

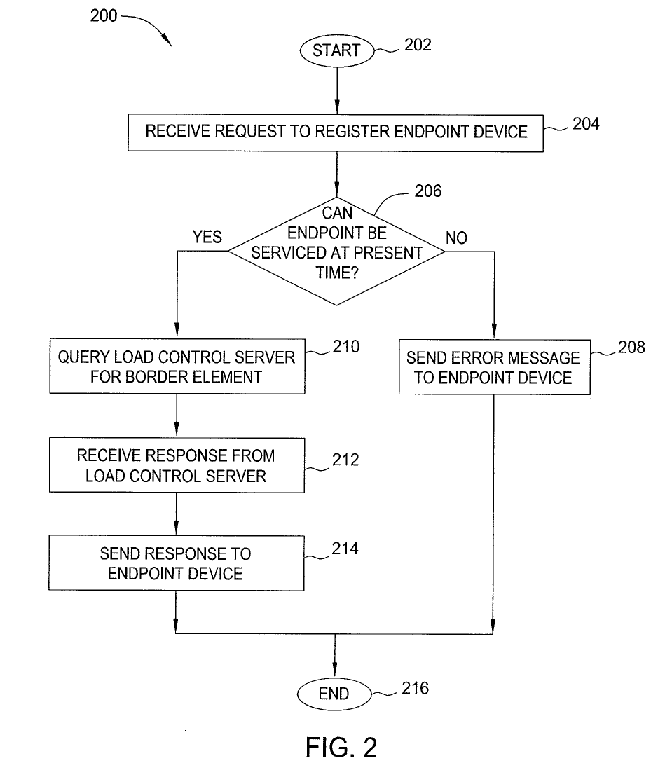

FIG. 2 is a flow diagram illustrating one embodiment of a method 200 for registering an endpoint device to a core network, according to the present disclosure. The method 200 may be implemented, for example, at the load distribution servers 115 and 117 illustrated in FIG. 1. As such, discussion of the method 200 makes reference to various components illustrated in FIG. 1. However, those skilled in the art will appreciate that the method 200 is not limited for use with network configurations such as that illustrated in FIG. 1.

The method 200 is initialized in step 202 and proceeds to step 204, where the load distribution server 115 receives a request from an endpoint device 102 to register the endpoint device 102 with the core network 110. In one embodiment, the request is a SIP REGISTER message.

In step 206, the load distribution server 115 determines whether the endpoint device 102 can be serviced at the present time. In one embodiment, the endpoint devices 102-107 are assigned varying levels of relative priority, based, for example, on their subscription status with the core network 110. For instance, endpoint devices 102-107 may pay different subscription fees for different priority levels. Servicing of endpoint devices 102-107 may then begin with higher priority endpoint devices and proceed to lower priority endpoints. Thus, endpoint devices 102-107 who are lower priority, or whose service is impaired, may not be able to be serviced at the present time.

If the load distribution server 115 determines in step 206 that the endpoint device 102 cannot be serviced at the present time, the load distribution server 115 sends an error message to the endpoint device 102 in step 208. The error message indicates that the endpoint device 102 should re-try its request at a later time. In one embodiment, the error message is a SIP 4xx/5xx error message. In another embodiment, the error message is a SIP 5xx message that includes a Retry-after header with a value determined by the load distribution server based on the current stare of the core network 110. Once the error message is sent, the method 200 terminates in step 216.

Alternatively, if the load distribution server 115 determines in step 206 that the endpoint device 102 can be serviced at the present time, then the method 200 proceeds to step 210, where the load distribution server 115 queries the load control server 112 for a border element 109 or 111 to which to assign the endpoint device 102. In step 212, the load distribution server 115 receives a response from the load control server 112. The response identifies a border element 109 to which to assign the endpoint device 102.

In step 214, the load distribution server 115 sends a response to the endpoint device 102. The response indicates the address of the border element 109 or 111 to which the endpoint device 102 has been assigned. In one embodiment, the response is a SIP 302 MOVED TEMPORARILY message. The method 200 then terminates in step 216.

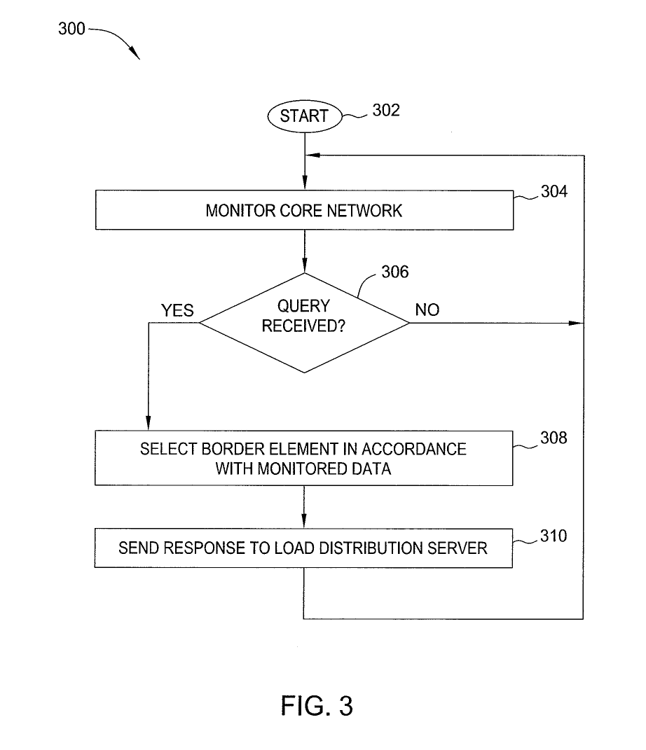

FIG. 3 is a flow diagram illustrating a second embodiment of a method 300 for registering an endpoint device to a core network, according to the present disclosure. The method 300 may be implemented, for example, at the load control server 112 illustrated in FIG. 1. As such, discussion of the method 300 makes reference to various components illustrated in FIG. 1. However, those skilled in the art will appreciate that the method 300 is not limited to use with network configurations such as that illustrated in FIG. 1.

The method 300 is initialized at step 302 and proceeds to step 304, where the load control server 112 monitors the core network 110. In one embodiment, the load control server 112 monitors various aspects of the core network 110 and/or its components, such as the general health, load, or other parameters. In one embodiment, the load control server 112 monitors the capacity of each border element 109 and 111. More specifically, the load control server 112 may monitor the capacity of a border element as a function of the border element's transactions or registrations per second or rate of endpoint loss (e.g., number of endpoints lost per second). In one embodiment, the load control server may monitor the number of endpoint devices whose registration expires and adjust the load distribution strategy if a border element experiences a sudden increase in the endpoints that lose registration.

In step 306, the load control server 112 determines whether a query has been received from a load distribution server 115. The query requests a border element 109-111 to which to assign an endpoint device 102. If the load control server 112 concludes in step 306 that no query has been received, the method 300 returns to step 304, and the load control server 112 continues to monitor the core network 110. Alternatively, if the load control server 112 concludes in step 306 that a query has been received, the method 300 proceeds to step 308.

In step 308, the load control server 112 selects a border element 109 to which to assign the endpoint device 102, in accordance with the monitored data. In one embodiment, this selection is based on the relative loads or capacities of all of the border elements 109 and 111 in the core network 110. The selection can be based on policies that balance one or more of the following monitored data: the arrival rate of initial registration requests, the arrival rate of other SIP requests (e.g., SIP INVITE requests), the number of subscribers currently registered on a border element, the total utilization of the border element, or other core network element resources (e.g., central processing unit, memory, bandwidth, etc.). Due to the variation of the total capacity of each of the individual network elements, the calculation is in one embodiment based on the ratio of the current consumed capacity to the total available capacity of the network elements. The load control server 112 then sends a response to the load distribution server 115 in step 310. The response identifies the address of the selected border element 109.

The method 300 then returns to step 304, and the load control server 112 continues to monitor the core network 110 until another query is received.

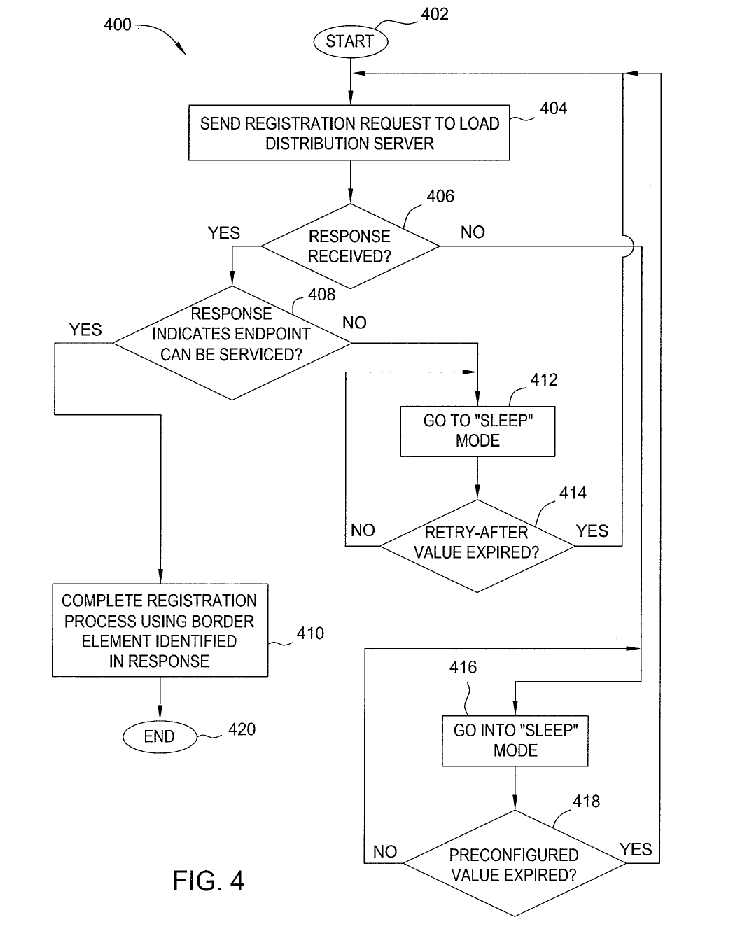

FIG. 4 is a flow diagram illustrating a third embodiment of a method 400 for registering an endpoint device to a core network, according to the present disclosure. The method 400 may be implemented, for example, at the endpoint devices 102-107 illustrated in FIG. 1. As such, discussion of the method 400 makes reference to various components illustrated in FIG. 1. However, those skilled in the art will appreciate that the method 400 is not limited to use with network configurations such as that illustrated in FIG. 1.

The method 400 is initialized in step 402 and proceeds to step 404, where the endpoint device 102-107 sends a request to a load distribution server 115 to register the endpoint device 102-107 with the core network 110. In one embodiment, the request is a SIP REGISTER message.

In step 406, the endpoint device 102-107 determines whether a response has been received from the load distribution server 115. If the endpoint device 102-107 concludes in step 406 that a response has not been received, the method 400 proceeds to step 416, where the endpoint device 102-107 goes into a “sleep” or inactive mode. In step 418, the endpoint device 102-107 determines whether a preconfigured value specifying a length of time for which the endpoint device 102-107 is to be in sleep mode has expired. If the preconfigured value has not expired, then the endpoint device 102-107 remains in sleep mode. Alternatively, if the preconfigured value has expired, then the endpoint device 102-107 returns to step 404 and sends a new registration request to the load distribution server 115.

Referring back to step 406, if the endpoint device 102-107 concludes in step 406 that a response has been received, the method 400 proceeds to step 408, where the endpoint device 102-107 determines whether the response indicates that the endpoint device 102-107 can be serviced at the present time. If the response indicates that the endpoint device 102-107 can be serviced at the present time, the response will include the address of a border element 109 or 111 to which the endpoint device 102 has been assigned. If the response indicates that the endpoint device 102-107 cannot be serviced at the present time, the response will include a Retry-after value that indicates when the endpoint device should re-try its request. In one embodiment, the response is a SIP 302 MOVED TEMPORARILY message.

If the response indicates that the endpoint device 102-107 can be serviced at the present time, then the endpoint device proceeds to step 410 and completes the registration process with the border element 109 or 111 indicated in the response from the load distribution server 115. In one embodiment, the endpoint device 102-107 initiates the registration process by sending a request to the border element 109 or 111 to register the endpoint device 102-107 with the core network 110. In one embodiment, the request is a SIP REGISTER message.

Alternatively, if the response indicates that the endpoint device 102-107 cannot be serviced at the present time, the endpoint device 102-107 goes into sleep mode in step 412. In step 414, the endpoint device 102-107 determines whether the Retry-after value specified in the response has expired. If the Retry-after value has not expired, then the endpoint device 102-107 remains in sleep mode. Alternatively, if the Retry-after value has expired, then the endpoint device 102-107 returns to step 404 and sends a new registration request to the load distribution server 115.

Once the registration process has been completed and the endpoint device 102-107 is registered with the core network 110, the method 400 terminates in step 410. Any future communications occur directly between the endpoint device 102 and the border element 109 or 111. It should be noted that in many modern operating systems, the loops from steps 414 and 418 may not be necessary. In such systems, a sleep timer can be implemented in another process or thread with a call back function.

By offloading handling of the registration flood to less stressed network elements, the border elements are substantially shielded from receiving messages in quantities that can cause the border elements to become overwhelmed. Thus, registration of the endpoint devices with the core network is controlled in a manner that substantially reduces the occurrence of registration floods that are so prevalent after catastrophic network failures. Moreover, this approach does not require modification of the border elements or the endpoint devices.

In further embodiments, enhancements can be made for the interface between the load distribution servers 115 and 117 and the load control server 112. For instance, in some embodiments, the load distribution servers 115 and 117 store data monitored by the load control server 112 (e.g., core network health, load, etc.) in their local memory caches. This allows the load distribution servers 115 and 117 to assign border elements 109 and 111 to endpoint devices 102-107 based on the data in their local memories, without querying the load control server 112. Thus, step 210-212 of the method 200 may be considered optional or can be implemented as a periodic exercise. In this case, the load control server 112 will periodically update the data that is cached by the load distribution servers 115 and 117.

In yet a further embodiment, at least one of the endpoint devices 102 is assigned a designated border element 109 as a primary point of contact and a designated load distribution server 115 as a secondary point of contact. In a normal mode of operation, the endpoint device 102 will register with the core network 110 via the designated border element 109. However, when a registration flood occurs and the designated border element 109 becomes overloaded, the designated border element 109 may reject the registration request (or not respond at all). Consequently, when the endpoint device 102 receives an error message (or times out without a response), the endpoint device 102 will re-attempt to register through the designated load distribution server 115. The methods 200-400 are then implemented as described above. In another embodiment, endpoint devices can be configured to send the registration request to the load distribution server after the endpoint devices reboot or re-initialize or fail to register to the pre-configured primary border elements.

In further embodiments still, the present invention is implemented to assist in fault isolation. For instance, when troubleshooting an issue related to a specific endpoint device 102, the load control server 112 is updated to force the endpoint device 102 to register via a special border element 109 after the endpoint device 102 experiences a reboot (restart). This allows for additional diagnostics to be performed.

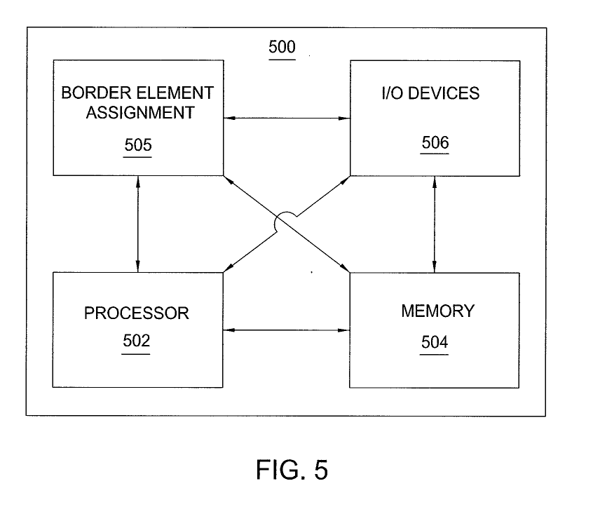

FIG. 5 is a high level block diagram of the border element assignment method that is implemented using a general purpose computing device 500. In one embodiment, a general purpose computing device 500 comprises a processor 502, a memory 504, a border element assignment module 505 and various input/output (I/O) devices 506 such as a display, a keyboard, a mouse, a modem, a stylus, a joystick, a keypad, controller, a sensor, a networking device (or multiple instances thereof), and the like. In one embodiment, at least one I/O device is a storage device (e.g., a disk drive, an optical disk drive, a floppy disk drive). It should be understood that the border element assignment module 505 can be implemented as a physical device or subsystem that is coupled to a processor through a communication channel.

Alternatively, the border element assignment module 505 can be represented by one or more software applications (or even a combination of software and hardware, e.g., using Application Specific Integrated Circuits (ASIC)), where the software is loaded from a storage medium (e.g., I/O devices 506) and operated by the processor 502 in the memory 504 of the general purpose computing device 500. Thus, in one embodiment, the border element assignment module 505 for dynamically assigning border elements to endpoint devices described herein with reference to the preceding Figures can be stored on a computer readable storage medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for registering an endpoint device with a core Internet Protocol network, the method comprising:
selecting a border element in the network, where the border element is selected based on monitored data relating to at least one of: a condition of the network and a condition of at least one component of the network; and
sending, by a load distribution server, a message to the endpoint device instructing the endpoint device to register with the network via the border element.

2. The method of claim 1, wherein the selecting comprises:
querying a load control server for the border element; and
receiving a response from the load control server including an address of the border element.

3. The method of claim 2, wherein the load control server directly monitors and records the monitored data.

4. The method of claim 1, wherein the selecting comprises:
retrieving the monitored data from a local memory of the load distribution server.

5. The method of claim 4, wherein the local memory is periodically updated by a load control server that directly monitors and records the monitored data.

6. The method of claim 1, further comprising:
determining, prior to the selecting, whether the endpoint device can be serviced at a present time.

7. The method of claim 6, wherein the determining is based on a priority of the endpoint device relative to other endpoint devices attempting to register with the network.

8. The method of claim 1, wherein the network is a Voice over Internet Protocol network.

9. The method of claim 1, wherein the message is a session initiation protocol message.

10. A computer readable storage medium containing an executable program for registering an endpoint device with a core Internet Protocol network, where the program performs steps of:
selecting a border element in the network, where the border element is selected based on monitored data relating to at least one of: a condition of the network and a condition of at least one component of the network; and
sending, by a load distribution server, a message to the endpoint device instructing the endpoint device to register with the network via the border element.

11. The computer readable storage medium of claim 10, wherein the selecting comprises:
querying a load control server for the border element; and
receiving a response from the load control server including an address of the border element.

12. The computer readable storage medium of claim 11, wherein the load control server directly monitors and records the monitored data.

13. The computer readable storage medium of claim 10, wherein the selecting comprises:
retrieving the monitored data from a local memory of the load distribution server.

14. The computer readable storage medium of claim 13, wherein the local memory is periodically updated by a load control server that directly monitors and records the monitored data.

15. The computer readable storage medium of claim 10, further comprising:
determining, prior to the selecting, whether the endpoint device can be serviced at a present time.

16. The computer readable storage medium of claim 15, wherein the determining is based on a priority of the endpoint device relative to other endpoint devices attempting to register with the network.

17. The computer readable storage medium of claim 10, wherein the network is a Voice over Internet Protocol network.

18. The computer readable storage medium of claim 10, wherein the message is a session initiation protocol message.

19. A system for registering an endpoint device with a core Internet Protocol network, the system comprising:
means for selecting a border element in the network, where the border element is selected based on monitored data relating to at least one of: a condition of the network and a condition of at least one component of the network; and
means for sending, by a load distribution server, a message to the endpoint device instructing the endpoint device to register with the network via the border element.

20. The system of claim 19, wherein the means for selecting comprises:
means for sending a query for the border element; and
means for receiving a response including an address of the border element.
